(19) United States
(12) Patent Application Publication
(10) Pub. No.: US 2008/0278935 A1
(43) Pub. Date: Nov. 13, 2008

(54) Multifunctional mirror lamp that can be mounted on a wall or a table

(76) Inventor: Shih-Ming Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/801,399

(22) Filed: May 10, 2007

(51) Int. Cl. F21V 21/30; F21L 4/00

(52) U.S. Cl. 362/183; 362/235; 362/433

(57) ABSTRACT

A mirror lamp includes a mirror lamp body, a hanging plate mounted on the mirror lamp body, and a wall attachment plate detachably combined with the hanging plate. Thus, the hanging plate is hung on the wall attachment plate to attach the mirror lamp body to a wall so that the mirror lamp functions as a wall lamp or a night lamp. In addition, the hanging plate is detachable from the wall attachment plate so that the mirror lamp body is operated individually to provide an illuminating function and to provide a dressing or make-up function. Further, when the mirror lamp body is operated individually, the base of the mirror lamp body is mountable on a table so that the mirror lamp functions as a table lamp.

### BACKGROUND OF THE INVENTION

1. Field of the Invention

The present invention relates to a lamp and, more particularly, to a mirror lamp to provide illuminating, dressing and make-up functions.

2. Description of the Related Art

A table lamp is mounted on a table to provide an illuminating function, and a wall lamp is mounted on a wall to provide an illuminating function. However, the conventional table lamp or wall lamp only has a single function, so that a user has to prepare multiple table lamps or wall lamps in the house, thereby causing inconvenience to the user, and thereby increasing the costs of fabrication. In addition, the conventional table lamp or wall lamp cannot function as a mirror, thereby limiting the versatility of the lamp.

### BRIEF SUMMARY OF THE INVENTION

In accordance with the present invention, there is provided a mirror lamp, comprising a mirror lamp body, a hanging plate mounted on the mirror lamp body, and a wall attachment plate detachably combined with the hanging plate.

The primary objective of the present invention is to provide a multifunctional mirror lamp that can be mounted on a wall or a table.

Another objective of the present invention is to provide a mirror lamp, wherein the hanging plate is hung on the wall attachment plate to attach the mirror lamp body to the wall so that the mirror lamp functions as a wall lamp or a night lamp.

A further objective of the present invention is to provide a mirror lamp, wherein the hanging plate is detachable from the wall attachment plate to remove the mirror lamp body from the wall attachment plate so that the mirror lamp body is operated individually to provide an illuminating function by the light emitting members and the reflective shade and to provide a dressing or make-up function by the concave mirror.

A further objective of the present invention is to provide a mirror lamp, wherein when the mirror lamp body is operated individually, the base of the mirror lamp body is mountable on a table so that the mirror lamp functions as a table lamp.

A further objective of the present invention is to provide a mirror lamp, wherein the mirror lamp has multiple functions so that a user only needs to provide the single mirror lamp to replace other lamps and mirrors, thereby facilitating the user employing the mirror lamp.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a mirror lamp in accordance with the preferred embodiment of the present invention.

FIG. 2 is a side cross-sectional assembly view of the mirror lamp as shown in FIG. 1.

FIG. 3 is a partially perspective assembly view of the mirror lamp as shown in FIG. 1.

FIG. 4 is a front view showing the mirror lamp being mounted on a wall.

FIG. 5 is a side view of the mirror lamp as shown in FIG. 4.

FIG. 6 is a schematic operational view of the mirror lamp as shown in FIG. 3 in use.

### DETAILED DESCRIPTION OF THE INVENTION

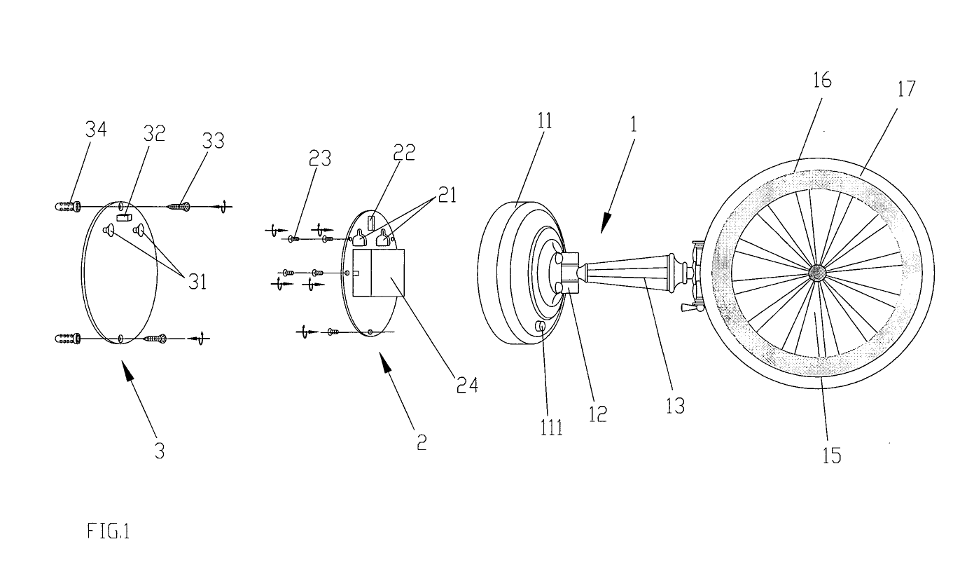

Referring to the drawings and initially to FIGS. 1-3, a mirror lamp in accordance with the preferred embodiment of the present invention comprises a mirror lamp body 1, a hanging plate 2 mounted on the mirror lamp body 1, and a wall attachment plate 3 detachably combined with the hanging plate 2.

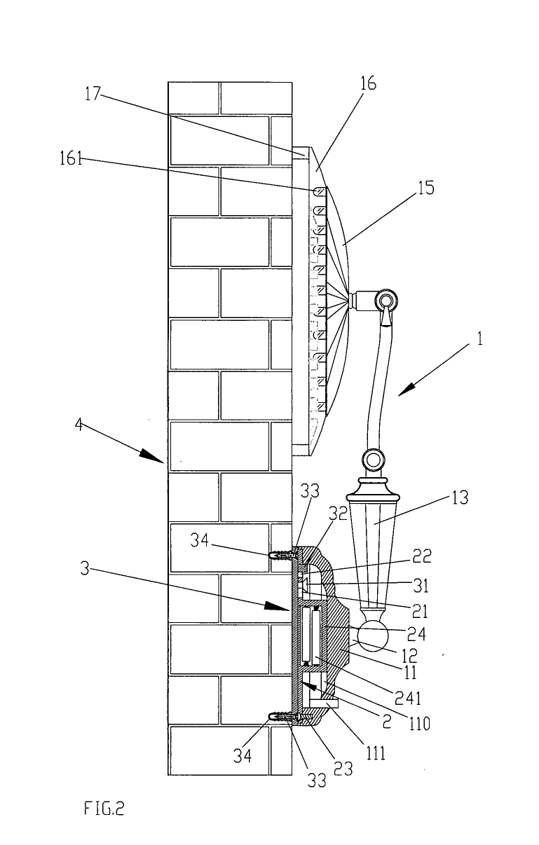

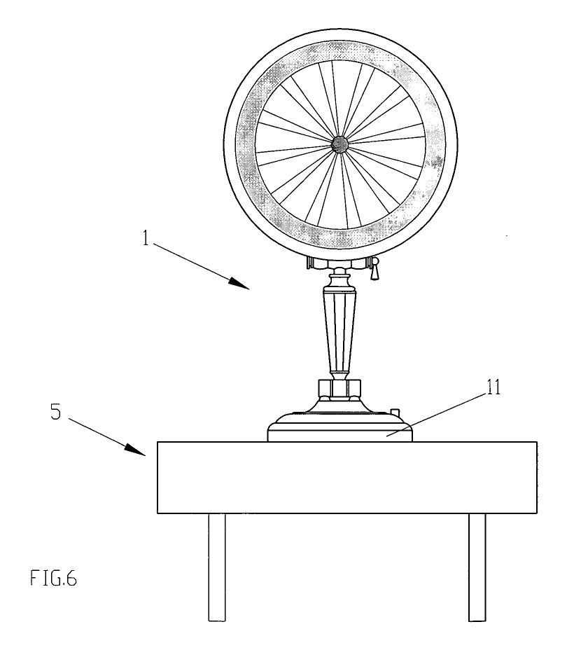

The mirror lamp body 1 includes a base 11, a pivot arm 13 having a first end pivotally mounted on a first side of the base 11, a mirror frame 17 mounted on a second end of the pivot arm 13 to move with the pivot arm 13, a reflective shade 16 mounted on the mirror frame 17, a plurality of light emitting members 161 mounted in the reflective shade 16, a push button 111 movably mounted on the first side of the base 11 and electrically connected to the light emitting members 161 to control operation of the light emitting members 161, and a concave mirror 15 mounted on the mirror frame 17 and located in the reflective shade 16. The base 11 of the mirror lamp body 1 is mountable on a table 5 as shown in FIG. 6. The base 11 of the mirror lamp body 1 has a substantially cylindrical shape and has a hollow inside formed with a receiving chamber 110 (see FIG. 2). The first end of the pivot arm 13 of the mirror lamp body 1 is pivotally mounted on the first side of the base 11 by a pivot seat 12.

The hanging plate 2 is mounted on a second side of the base 11 of the mirror lamp body 1 by a plurality of locking screws 23 which are extended through a peripheral wall of the hanging plate 2 and screwed into a peripheral wall of the second side of the base 11 of the mirror lamp body 1 to fix the hanging plate 2 onto the base 11 of the mirror lamp body 1. The hanging plate 2 has a substantially circular shape and is fully hidden in the base 11 of the mirror lamp body 1 as shown in FIG. 2 to seal the receiving chamber 110 of the base 11 of the mirror lamp body 1. The hanging plate 2 has a surface formed with an elongated guide slot 22 and two locking holes 21.

The mirror lamp further comprises a battery box 24 mounted on the hanging plate 2 and received in the receiving chamber 110 of the base 11 of the mirror lamp body 1, and at least one recharageable battery 241 mounted in the battery box 24 and electrically connected to the light emitting members 161 to supply an electric power to the light emitting members 161.

The wall attachment plate 3 has a first side formed with two locking posts 31 each inserted into and detachably locked in a respective locking hole 21 of the hanging plate 2 to hang the hanging plate 2 onto the wall attachment plate 3 and a second side mountable onto a wall 4 to attach the hanging plate 2 and the mirror lamp body 1 to the wall 4. The first side of the wall attachment plate 3 is formed with a protruding slide 32 slidably mounted in the guide slot 22 of the hanging plate 2 to guide movement of the hanging plate 2 relative to the wall attachment plate 3. The wall attachment plate 3 has a substantially circular shape and has a diameter greater than that of the hanging plate 2.

The mirror lamp further comprises a plurality of tapered sleeves 34 each inserted into the wall 4 and rested on the second side of the wall attachment plate 3, and a plurality of tapered screws 33 each extended through a peripheral wall of the wall attachment plate 3 and each screwed into a respective tapered sleeve 34 to attach the wall attachment plate 3 to the wall 4.

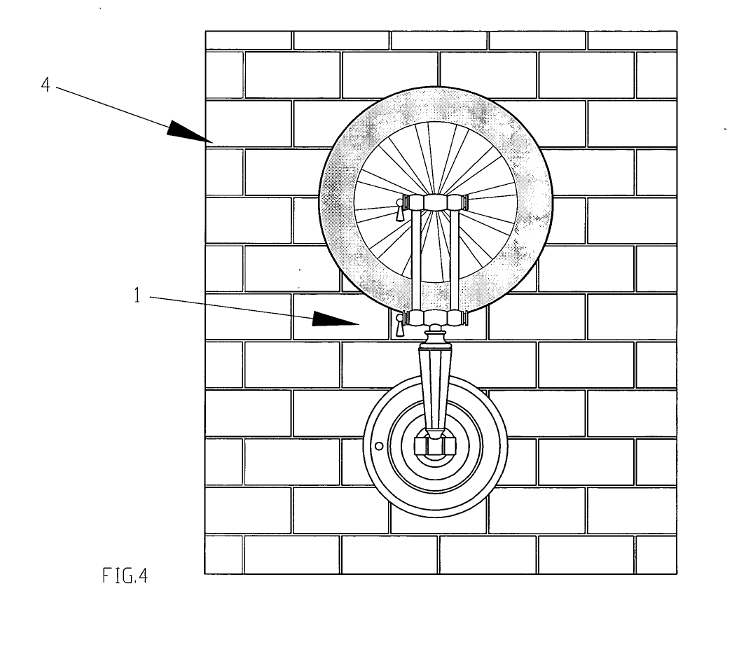

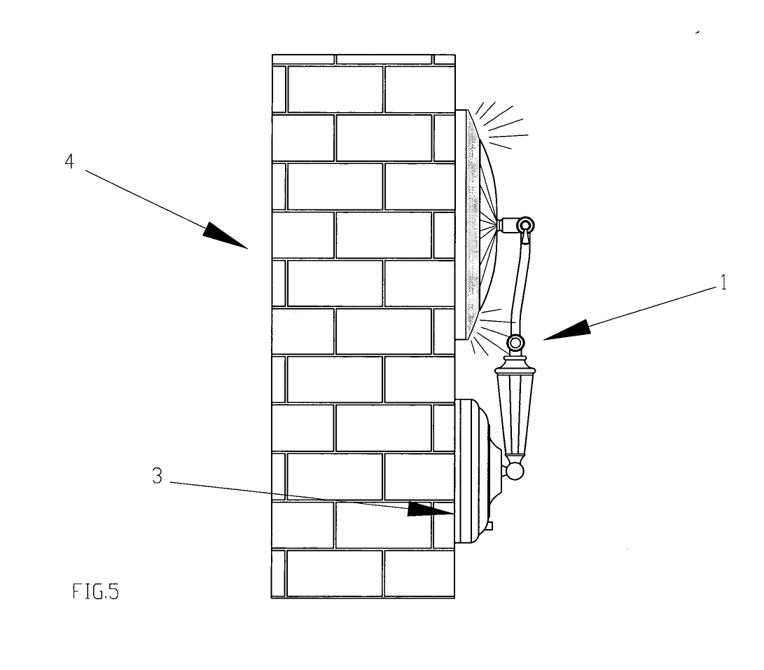

In assembly, referring to FIGS. 4 and 5 with reference to FIGS. 1-3, the locking screws 23 are extended through a peripheral wall of the hanging plate 2 and screwed into a peripheral wall of the second side of the base 11 of the mirror lamp body 1 to fix the hanging plate 2 onto the base 11 of the mirror lamp body 1. Then, each of the tapered screws 33 is extended through a peripheral wall of the wall attachment plate 3 and screwed into a respective tapered sleeve 34 to attach the wall attachment plate 3 to the wall 4. Then, when the hanging plate 2 is mounted on the wall attachment plate 3, each of the locking posts 31 of the wall attachment plate 3 is inserted into and detachably locked in a respective locking hole 21 of the hanging plate 2 to hang the hanging plate 2 onto the wall attachment plate 3 so as to attach the mirror lamp body 1 to the wall 4. At this time, the slide 32 of the wall attachment plate 3 is slidable in the guide slot 22 of the hanging plate 2 to guide movement of the hanging plate 2 relative to the wall attachment plate 3.

In such a manner, when the pivot arm 13 is pivotable relative to the base 11, the mirror frame 17 of the mirror lamp body 1 is movable with the pivot arm 13 to rest on the wall 4 as shown in FIGS. 2 and 5 so that the mirror lamp functions as a wall lamp or a night lamp.

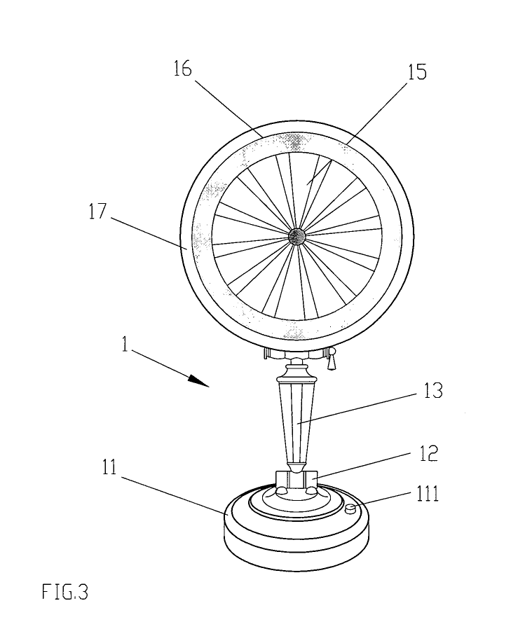

As shown in FIGS. 1 and 3, the hanging plate 2 is detachable from the wall attachment plate 3 to remove the mirror lamp body 1 from the wall attachment plate 3 so that the mirror lamp body 1 is operated individually. In such a manner, the mirror lamp body 1 provides an illuminating function by the light emitting members 161 and the reflective shade 16 and provides a dressing or make-up function by the concave mirror 15.

As shown in FIG. 6, the base 11 of the mirror lamp body 1 is mountable on a table 5 so that the mirror lamp functions as a table lamp.

Accordingly, the hanging plate 2 is hung on the wall attachment plate 3 to attach the mirror lamp body 1 to the wall 4 so that the mirror lamp functions as a wall lamp or a night lamp. In addition, the hanging plate 2 is detachable from the wall attachment plate 3 to remove the mirror lamp body 1 from the wall attachment plate 3 so that the mirror lamp body 1 is operated individually to provide an illuminating function by the light emitting members 161 and the reflective shade 16 and to provide a dressing or make-up function by the concave mirror 15. Further, when the mirror lamp body 1 is operated individually, the base 11 of the mirror lamp body 1 is mountable on a table 5 so that the mirror lamp functions as a table lamp. Further, the mirror lamp has multiple functions so that a user only needs to provide the single mirror lamp to replace other lamps and mirrors, thereby facilitating the user employing the mirror lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A mirror lamp, comprising:
a mirror lamp body;
a hanging plate mounted on the mirror lamp body;
a wall attachment plate detachably combined with the hanging plate.

2. The mirror lamp in accordance with claim 1, wherein the mirror lamp body includes:
a base;
a pivot arm having a first end pivotally mounted on a first side of the base;
a mirror frame mounted on a second end of the pivot arm to move with the pivot arm;
a reflective shade mounted on the mirror frame;
a plurality of light emitting members mounted in the reflective shade;
a concave mirror mounted on the mirror frame and located in the reflective shade.

3. The mirror lamp in accordance with claim 2, wherein the base of the mirror lamp body is mountable on a table.

4. The mirror lamp in accordance with claim 2, wherein the base of the mirror lamp body has a substantially cylindrical shape.

5. The mirror lamp in accordance with claim 2, wherein the first end of the pivot arm of the mirror lamp body is pivotally mounted on the first side of the base by a pivot seat.

6. The mirror lamp in accordance with claim 2, wherein the hanging plate is mounted on a second side of the base of the mirror lamp body.

7. The mirror lamp in accordance with claim 6, wherein the hanging plate is mounted on the second side of the base of the mirror lamp body by a plurality of locking screws which are extended through a peripheral wall of the hanging plate and screwed into a peripheral wall of the second side of the base of the mirror lamp body to fix the hanging plate onto the base of the mirror lamp body.

8. The mirror lamp in accordance with claim 1, wherein the hanging plate has a substantially circular shape.

9. The mirror lamp in accordance with claim 6, wherein:
the base of the mirror lamp body has a hollow inside formed with a receiving chamber;
the hanging plate is fully hidden in the base of the mirror lamp body to seal the receiving chamber of the base of the mirror lamp body.

10. The mirror lamp in accordance with claim 9, further comprising:
a battery box mounted on the hanging plate and received in the receiving chamber of the base of the mirror lamp body;
at least one recharageable battery mounted in the battery box and electrically connected to the light emitting members to supply an electric power to the light emitting members.

11. The mirror lamp in accordance with claim 2, wherein the mirror lamp body further includes a push button movably mounted on the first side of the base and electrically connected to the light emitting members to control operation of the light emitting members.

12. The mirror lamp in accordance with claim 2, wherein:
the hanging plate has a surface formed with two locking holes;
the wall attachment plate has a first side formed with two locking posts each inserted into and detachably locked in a respective locking hole of the hanging plate to hang the hanging plate onto the wall attachment plate.

13. The mirror lamp in accordance with claim 12, wherein:
the surface of the hanging plate is formed with an elongated guide slot;
the first side of the wall attachment plate is formed with a protruding slide slidably mounted in the guide slot of the hanging plate to guide movement of the hanging plate relative to the wall attachment plate.

14. The mirror lamp in accordance with claim 12, wherein the wall attachment plate has a second side mountable onto a wall to attach the hanging plate and the mirror lamp body to the wall.

15. The mirror lamp in accordance with claim 14, further comprising:
a plurality of tapered sleeves each inserted into the wall and rested on the second side of the wall attachment plate;
a plurality of tapered screws each extended through a peripheral wall of the wall attachment plate and each screwed into a respective tapered sleeve to attach the wall attachment plate to the wall.

16. The mirror lamp in accordance with claim 8, wherein the wall attachment plate has a substantially circular shape.

17. The mirror lamp in accordance with claim 16, wherein the wall attachment plate has a diameter greater than that of the hanging plate.

18. The mirror lamp in accordance with claim 12, wherein when the hanging plate is mounted on the wall attachment plate, each of the locking posts of the wall attachment plate is inserted into and detachably locked in a respective locking hole of the hanging plate to hang the hanging plate onto the wall attachment plate so as to attach the mirror lamp body to the wall.

19. The mirror lamp in accordance with claim 14, wherein when the pivot arm is pivotable relative to the base, the mirror frame of the mirror lamp body is movable with the pivot arm to rest on the wall.

20. The mirror lamp in accordance with claim 1, wherein the hanging plate is detachable from the wall attachment plate to remove the mirror lamp body from the wall attachment plate so that the mirror lamp body is operated individually.
